(19) United States
(12) Patent Application Publication
(10) Pub. No.: US 2007/0272043 A1
(43) Pub. Date: Nov. 29, 2007

(54) Variable Vibrator Mechanism

(76) Inventor: Joe O'Connor, North Ireland (GB)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/574,634

(22) PCT Filed: Sep. 30, 2004
(86) PCT No.: PCT/GB04/04157

§ 371 Date: Mar. 22, 2007

(30) Foreign Application Priority Data
Oct. 3, 2003 (GB) 0323174.3

(51) Int. Cl. B06B 1/16

(52) U.S. Cl. 74/61

(57) ABSTRACT

A variable vibrator mechanism (10) for feeder machines. The vibrator mechanism (10) includes a first member (12) and a second member (14) arranged telescopically with one another. The first member (12) and second member (14) have eccentric weights (axially offset) (16, 26), and are adapted such that the rotational displacement between the eccentric weights (16, 26) is varied by varying the longitudinal displacement between the first and second member (12, 14). Thus allowing the vibrational characteristics of the vibrator to be adjusted by simply varying the displacement between the first and second members (12, 14).

The present invention relates to a variable vibrator mechanism for use in machinery, especially, but not exclusively, for use in vibrating screen and vibrating feeder machines in the re-cycling and quarrying industries.

References herein to a vibrating screen machine are understood to mean any vibrating machine which separates loose material according to its particle size, and references herein to a vibrating feeder machine are understood to mean any vibrating machine which feeds material to an apparatus. Both of these machines are well known in the field, and therefore no further explanation will be given here.

Conventional vibrator mechanisms used in vibrating horizontal screens and vibrating feeders operate on the principal of eccentric weights located on counter rotating shafts which generate a resultant vibration of the mechanism which is translated to the screens and feeders. The amplitude and direction of the resultant vibration can be altered to suit the characteristics of feed material by varying the rotational displacement between the eccentric weights and/or varying the mass of the eccentric weights. Altering the amplitude and direction of the resultant vibration of the mechanism involves stopping the machinery, removing the covers of the drive mechanisms, and physically changing the rotational displacement and/or mass of the weights. This typically involves between four and eight hours work by two skilled technicians, with an inherent safety risk due to nature of the drive mechanism, along with a loss of production due to the downtime of the machine.

It is an object of the present invention to provide a vibrator mechanism which obviates or mitigates one or more of the disadvantages referred to above.

According to a first aspect of the present invention there is provided a variable vibrator mechanism comprising:
a first member and a second member arranged telescopically with one another,
wherein said first member has a first eccentric weight and said second member has a second eccentric weight,
wherein said first and second members are adapted to be engaged with one another, such that the rotational displacement between said first eccentric weight and said second eccentric weight may be varied by varying the longitudinal displacement between said first and second members.

Preferably, the second member is adapted to telescopically receive the first member. Alternatively, the first member is adapted to telescopically receive the second member.

Preferably, the first and second members are adapted to be threadably engaged with one another.

Preferably, the first and second members are cylindrical.

Preferably, the variable vibrator mechanism comprises two first members arranged telescopically with said second member, wherein the two first members and the second member are adapted to be engaged with one another, such that the rotational displacement between the first eccentric weights and the second eccentric weight may be varied by varying the longitudinal displacement between the first members and the second member.

Preferably, the variable vibrator mechanism further comprises means for telescopically displacing the first and second members. Preferably the means for telescopically displacing the first and second members is a hydraulic ram. Alternatively, the means for telescopically displacing the first and second members is mechanically driven shaft.

Preferably, the variable vibrator mechanism comprises a plurality of pairs of first and second members, wherein each pair of first and second members are arranged telescopically with one another. More preferably, the variable vibrator mechanism comprises two pairs of first and second members. More preferably, the variable vibrator mechanism comprises three pairs of first and second members.

Preferably, the variable vibrator mechanism is constructed of metal.

According to a second aspect of the present invention, there is provided a vibrating screen machine including a variable vibrator mechanism in accordance with the first aspect of the present invention.

According to a third aspect of the present invention, there is provided a vibrating horizontal or inclined feeder machine including a variable vibrator mechanism in accordance with the first aspect of the present invention.

Embodiments of the present invention will now be described, by way of example only, with reference to the accompanying drawings, in which:—

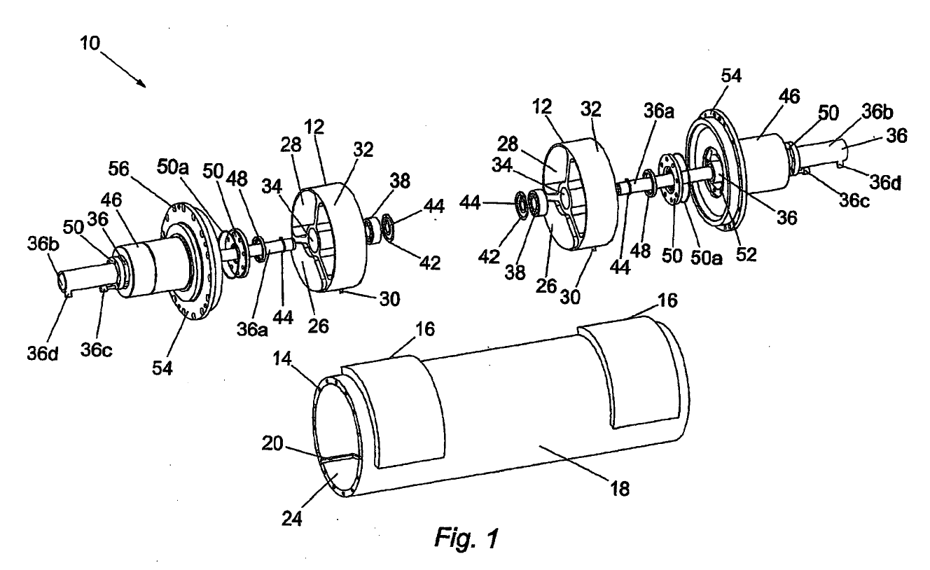

FIG. 1 is a perspective exploded view of a variable vibrator mechanism in accordance with the present invention;

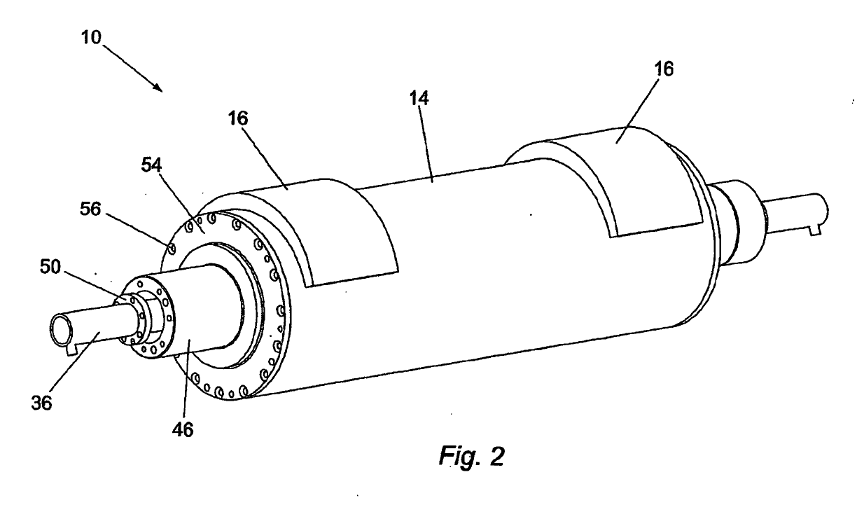

FIG. 2 is a perspective view of an assembled variable vibrator mechanism;

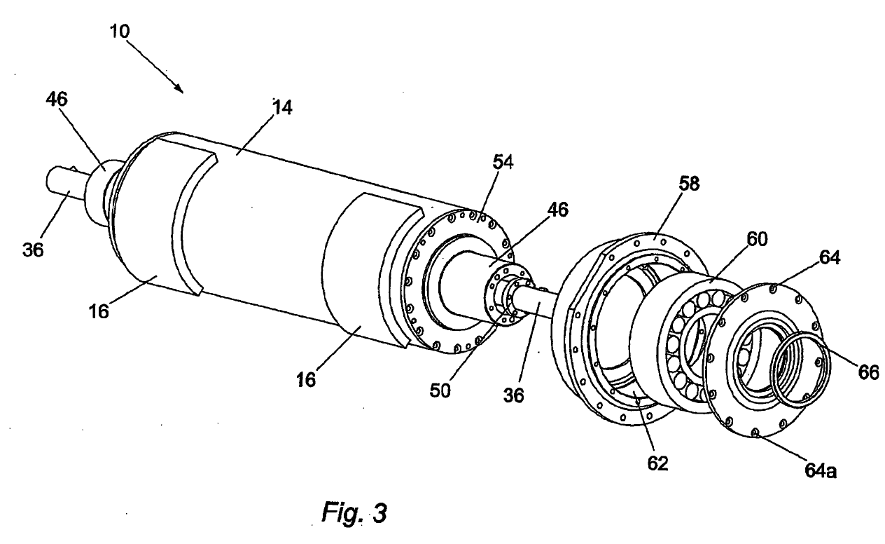

FIG. 3 is a perspective view of a variable vibrator mechanism of FIG. 2 further including an outer bearing, housing and cap plate;

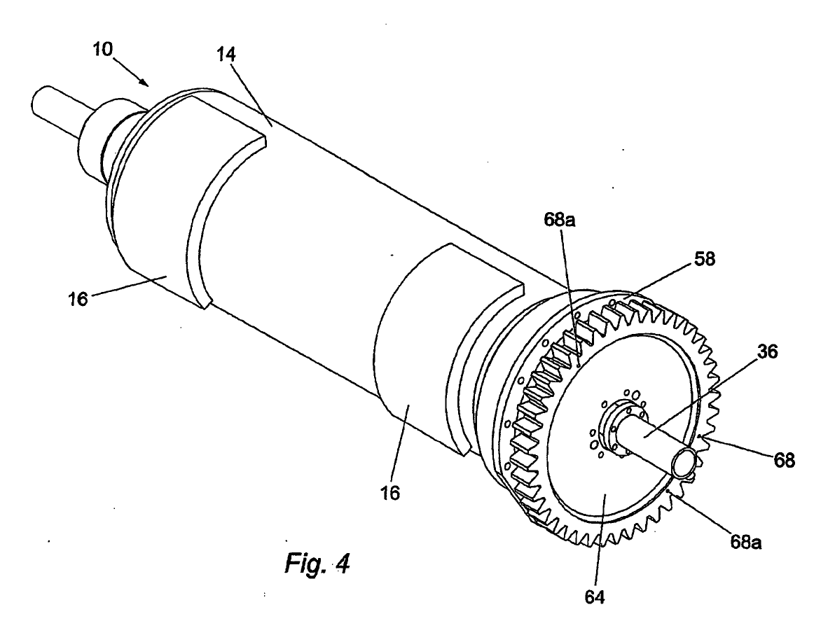

FIG. 4 is a perspective view of a variable vibrator mechanism of FIG. 3 further including a drive gear;

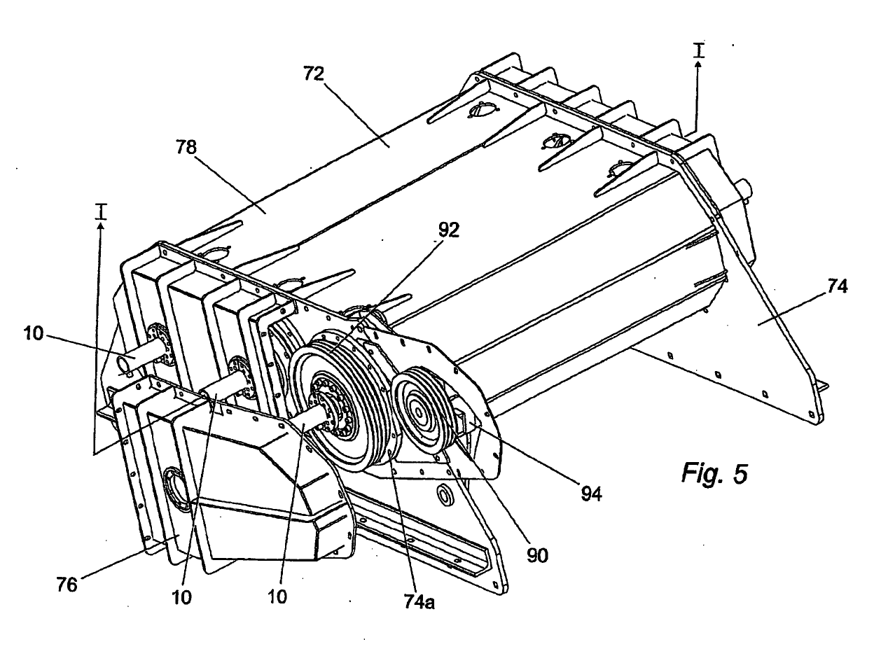

FIG. 5 is a perspective view of a variable vibrator apparatus including three variable vibrator mechanisms of FIG. 4;

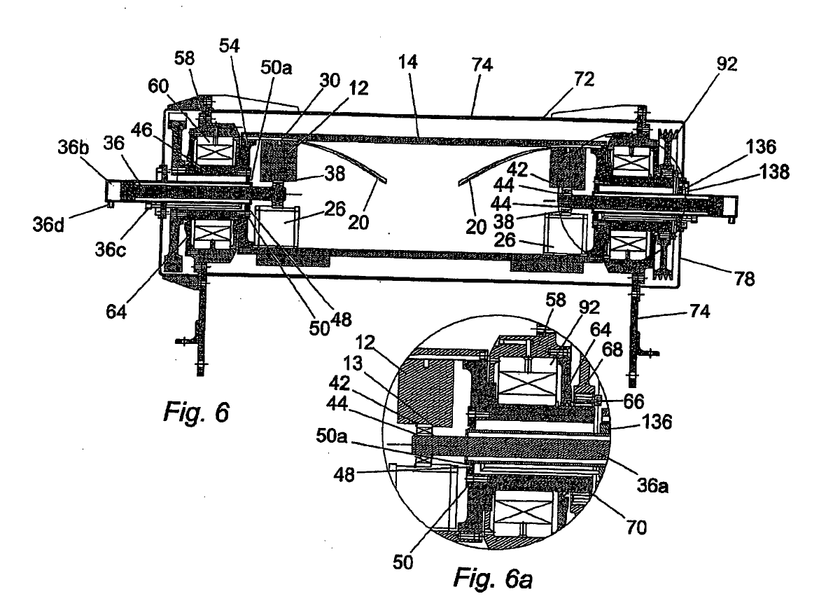

FIG. 6 is a cross-sectional view of the variable vibrator apparatus of FIG. 5 along line I-I of FIG. 5;

FIG. 6a is an enlarged view of one end of the variable vibrator mechanism of FIG. 6;

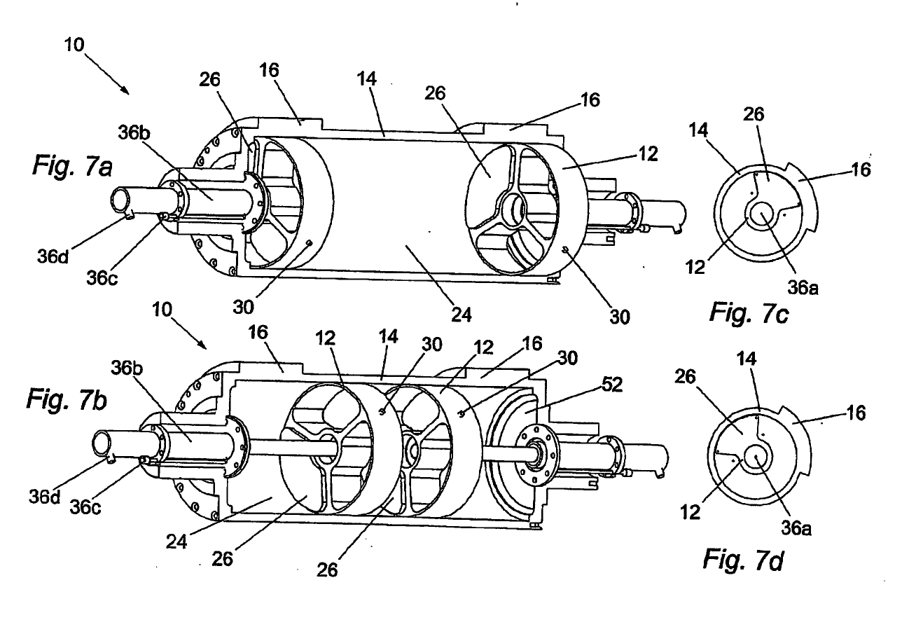

FIGS. 7a and 7b are perspective part cut-away views of the variable vibrator apparatus of FIG. 1;

FIGS. 7c and 7d are schematic end views of the variable vibrator mechanism of FIGS. 7a and 7b, respectively;

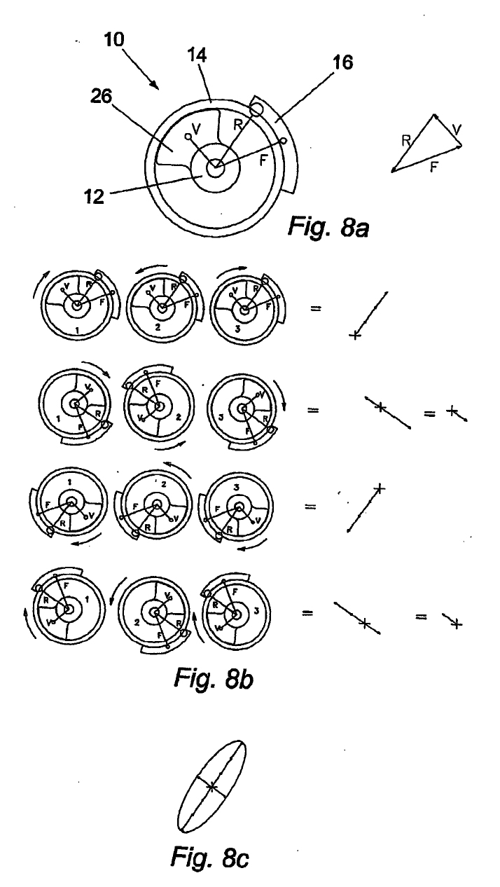

FIG. 8a is a schematic end view of the variable vibrator mechanism of FIG. 2, wherein the eccentric weights of the first and second members are rotationally offset to a maximum position from one another;

FIG. 8b illustrates the operation of three counter rotating variable vibrator mechanisms of FIG. 8a, and shows the resultant displacement of the vibration at each quarter turn of rotation;

FIG. 8c illustrates the resultant vibration path of FIG. 8b;

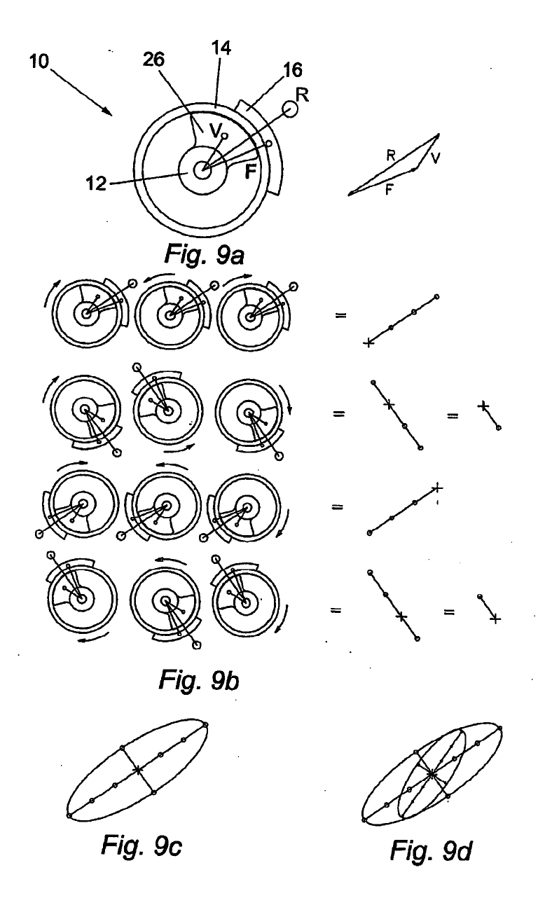

FIG. 9a is a schematic end view of the variable vibrator mechanism of FIG. 2, wherein the eccentric weights of the first and second members are rotationally offset to a minimum position from one another;

FIG. 9b illustrates the operation of three counter rotating variable vibrator mechanisms of FIG. 9a, and shows the resultant displacement of the vibration at each quarter turn of rotation;

FIG. 9c illustrates the resultant vibration path of FIG. 9b;

FIG. 9d illustrates the range of vibration paths available between the maximum and minimum vibration paths of FIGS. 8c and 9c; and

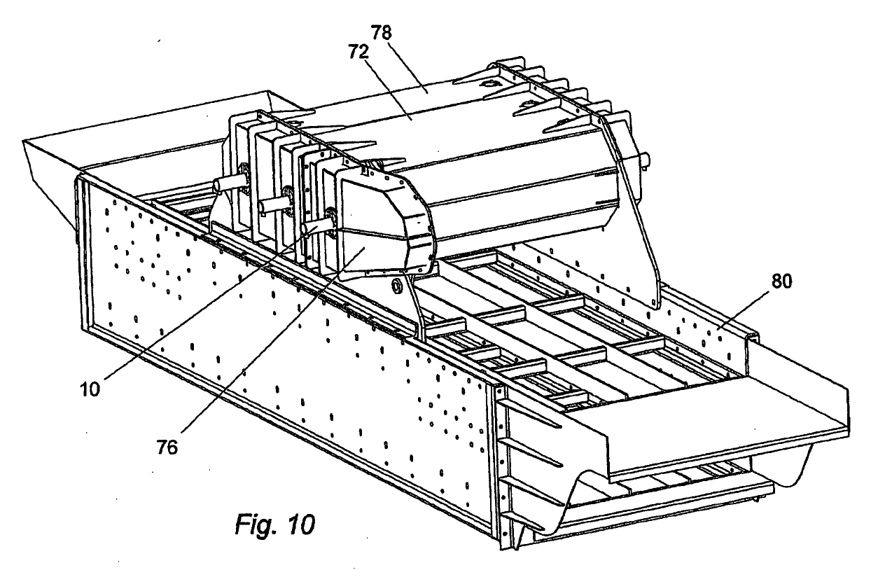

FIG. 10 is a perspective view of the variable vibrator apparatus of FIG. 5 as attached to a typical vibrating horizontal screen.

Referring to FIG. 1, a variable vibrator mechanism 10 comprises a pair of first members 12 and a second member 14 arranged telescopically with one another. That is to say the pair of first members 12 and the second member 14 are arranged to be received wholly or partly within one another.

The second member 14 is substantially cylindrical with a second eccentric weight 16 located on its outer circumferential surface 18 and two opposite spiral keyways 20 (see FIG. 6) cut into its inner circumferential surface 24. That is to say the second member 14 has a weight 16 which is offset from its central axis. The second eccentric weight 16 is illustrated in FIG. 1 as two separate weights located at opposite ends of the second member 14. However, it should be appreciated that the second eccentric weight 16 could be one continuous member offset from the central axis.

The first members 12 are also substantially cylindrical with first eccentric weights 26 located on their inner circumferential surfaces 28 and spigots 30 located on their outer circumferential surfaces 32. The first members 12 are also provided with bores 34 therethrough.

The first members 12 are rotatably mounted on hydraulic ram shafts 36a by bearings 38. The bearings 38 are mounted on the ram shafts 36a within the bores 34 of the first members 12 and each is held in place with respect to the first member 12 by a first circlip 42 and a shoulder 13 on the first member 12, seen most clearly in FIGS. 6 and 6a. Each bearing 38 is located on the ram shaft 36a by two second circlips 44, also seen most clearly in FIGS. 6 and 6a. Arranging the bearings 38, first circlips 42 and second circlips 44 in this manner prevents any longitudinal movement of the first members 12 on the hydraulic ram shafts 36a. As will be understood by the skilled person, other suitable types of bearing arrangements may be used as bearings 38, e.g. tapered roller bearings.

The hydraulic rams 36 comprise a piston shaft 36a and a piston housing 36b (as best illustrated in FIG. 6). The piston housings 36b further comprise hydraulic inlet and outlet ports 36c and 36d. The inlet and outlet ports 36c and 36d facilitate the hydraulic operation of the piston shafts 36a.

The piston housings 36b are surrounded by end stubs 46 which rotate with the second member 14. The hydraulic rams 36 and the end stubs 46 are sealed to each other by radial shaft seals 48 which are mounted in housings 50, so that the end stub 46 can rotate relative to the piston housing 36b. Housings 50 are located and fixed in recesses 52 of the end stubs 46, and sealed with an o-ring 50a. The end stubs 46 are substantially cylindrical with flange portions 54 secured to the second member 14.

The left hand end stub 46 in FIG. 6 is fixed to a drive gear 68 and is fixed longitudinally with respect to its corresponding ram 36, while the right hand end stub 46 in FIG. 6 is free to move longitudinally with respect to its corresponding ram 36, to allow for thermal expansion.

Referring to FIGS. 6 and 6a, the outer surface of each ram 36 has a flange 136 which is connected to a ram mounting plate 138 by bolts or the like, which in turn is bolted to the outer cover 78. In this way the hydraulic ram housing 36b is fixed and the ram shaft 36a is free to move under hydraulic control axially with respect to the housing 36b. It is to be understood that variations in the ram arrangement are possible so that the ram shaft 36a is fixed and the housing 36b moves, with appropriate redesign of the ram 36 and connections, as will be understood by the skilled person.

The variable vibrator mechanism 10 comprises a set of two first members 12 and hydraulic ram shaft assemblies 36 to ensure balance across the vibrator mechanism during operation. Spiral keyways 20 are oppositely cut into the second member 14 to ensure that the movement of the first members 12 along the second member 14 is balanced.

With reference to FIGS. 1 and 2, the first members 12 and the hydraulic ram shaft assemblies 36 are mounted within the second member 14 by firstly, locating the spigots 30 of the first members 12 within the spiral keyways 20 of the second member 14, and secondly, by securing the flange portions 54 to the second member 14 by bolts 56, or other fixing means, located on the outer edges of flange portions 54.

As illustrated in FIG. 3, an outer bearing housing 58 is fitted to one end of the variable vibrator mechanism 10. The outer bearing housing 58 includes an outer bearing 60 which is located in a recess 62 of the outer bearing housing 58 and held in place by a cap plate 64. The cap plate 64 is fixed to the outer bearing housing 58 by bolts 64a, or other fixing means. A radial shaft seal 66 is fitted into a recess in the cap plate 64, whilst an o-ring (not shown) is fitted between the outer bearing housing 58 and the cap plate 64.

As illustrated in FIG. 4, a drive gear 68 is fitted over the end stub 46 and held in place by fixing bolts 68a, or other fixing means. The drive gear 68 butts against the corresponding end stub 46 and is prevented from longitudinal movement thereto. As best seen in FIGS. 6 and 6a, a radial seal 66 seals between the end stub 46 and the cap plate 64.

The complete vibrator apparatus 72 is illustrated in FIG. 5. As seen in FIG. 5, the cover 76 is cut-away to show a typical drive pulley arrangement. As shown, the complete vibrator apparatus 72 comprises three variable vibrator mechanisms 10 arranged in a row. The variable vibrator mechanisms 10 are mounted to the vibrator housing 74 by means of bolts 74a between the outer bearing housing 58 and the vibrator housing 74. An o-ring (not shown) is fitted between the outer bearing housing 58 and the vibrator housing 74. The complete vibrator apparatus 72 (see FIG. 10) further comprises a cover 76 which encases the drive gears 68, and a screen 80 which carries the feed material (not shown) which is connected to the complete variable vibrator apparatus 72. Although the complete vibrator apparatus 72 is illustrated as comprising three variable vibrator mechanisms 10, it should be noted that it may contain any number of variable vibrator mechanisms 10. The variable vibrator apparatus 72 is driven, and thus the variable vibrator mechanisms 10 rotated, in a conventional manner by driving one of the mechanisms 10. FIG. 5 shows an example of a manner of driving. A hydraulic motor (not shown) drives a driver pulley 90 on arm 94, which in turn uses a drive belt (not shown) to drive a driven pulley 92 fitted to a mechanism 10 to drive the end stub 46.

FIG. 6 is a cross-sectional view of a variable vibrator mechanism 10 within the complete vibrator apparatus 72 along line I-I of FIG. 5, and FIG. 6a is an enlarged view of one end of the variable vibrator mechanism 10 of FIG. 6. FIGS. 7a and 7b are perspective part cut-away views of the variable vibrator apparatus 10. FIG. 6 shows the two opposite spiral keyways 20 of the second member 14. FIG. 6 also shows the internal operation of the hydraulic ram shafts 36.

As seen in FIGS. 6, 7a and 7b, when hydraulic pressure is applied to the piston housing 36b, via inlet ports 36c, the piston shafts 36a move the first members 12 towards the centre of the second member 14. As this happens the first and second members 12 and 14 threadably engage. The spigots 30 follow the spiral keyways 20 and rotate the first members 12 about the hydraulic ram shafts 36, thus varying the rotational displacement between the first and second eccentric weights 26 and 16. The piston shafts 36a and first members 12 are moved back to the edges of the second member 14 by reversing oil flow from the piston housing 36b via outlet ports 36d. FIGS. 7c and 7d show the rotational displacement between the first and second eccentric weights 26 and 16 between the two positions.

The hydraulic ram shafts 36 may include conventional remotely operated activation units (not shown) for moving the first members 12 into and out of the second member 14. This method of remotely operating a hydraulic system such as this is known and no further explanation is given here.

The operation of the complete vibrator apparatus 72 will now be described with reference to FIGS. 8a-9d. In this configuration the first eccentric weight 26 is termed the variable weight and the second eccentric weight 16 is termed the fixed weight.

FIG. 8a is a schematic end view of a variable vibrator mechanism 10 with the first and second eccentric weights 26 and 16 of the first and second members 12 and 14 rotationally offset from one another by approximately 90 degrees. In this embodiment of the present invention, 90 degrees is the maximum rotational offset between the first and second eccentric weights 26 and 16. However, it should be noted that first and second eccentric weights 26 and 16 may be offset from one another by any angle.

FIG. 8a illustrates the centripetal force components acting on the first and second eccentric weights 26 and 16 when the variable vibrator mechanism 10 is rotating. The centripetal force component of the first eccentric weight 26 is given the symbol “V” (variable), and the centripetal force component of the second eccentric weight 16 is given the symbol “F” (fixed). Also shown is the overall resultant centripetal force component acting on the variable vibrator mechanism 10. This resultant component is given the symbol “R” (resultant).

FIG. 8b illustrates the operation of the three variable vibrator mechanisms 10 of FIG. 8a. As seen in FIG. 8b, the first and third variable vibrator mechanisms 10 rotate clockwise, whilst the second variable vibrator mechanism 10 rotates counter-clockwise.

The four rows in FIG. 8b each illustrate the resultant displacement vibration component after a quarter-turn of the variable vibrator mechanisms 10. The overall effect of having three counter-rotating variable vibrator mechanisms 10 is to map out a vibration path which is elliptical, as illustrated in FIG. 8c.

FIG. 9a is a schematic end view of a variable vibrator mechanism 10 with the first and second eccentric weights 26 and 16 of the first and second members 12 and 14 rotationally offset from one another by a minimal amount.

Again, FIG. 9a illustrates the centripetal force components acting on the first and second eccentric weights 26 and 16 when the variable vibrator mechanism 10 is rotating. In this configuration the overall resultant centripetal force component acting on the variable vibrator mechanism 10 is greater than the previous configuration where the first and second eccentric weights 26 and 16 were rotationally offset from one another by approximately 90 degrees.

FIG. 9b illustrates the operation of the three variable vibrator mechanisms 10 of FIG. 9a. As seen in FIG. 9b, again the first and third variable vibrator mechanisms 10 rotate clockwise, whilst the second variable vibrator mechanisms 10 rotates counter-clockwise.

Again, the four rows in FIG. 9b each illustrate the resultant displacement vibration component after a quarter-turn of the variable vibrator mechanisms 10.

FIG. 9c again illustrates the overall elliptical vibration path. In this configuration the resultant vibration path is greater than the previous configuration where the first and second eccentric weights 26 and 16 were rotationally offset from one another by approximately 90 degrees.

The configuration of the first and second eccentric weights 26 and 16 of FIG. 8a results in a minimum vibration path, whereas the configuration of the first and second eccentric weights 26 and 16 of FIG. 9a results in a maximum vibration path. The vibration paths available between these two configurations, the maximum vibration path 8a and the minimum vibration path 8b, are illustrated in FIG. 9d.

FIG. 10 illustrates the complete vibrator apparatus 72 of FIG. 5 as applied to a typical vibrating horizontal screen 80. The vibrating screen 80 operates in a conventional manner which is known, and as such no further description will be given here.

The preferred material of construction for all metal components of variable vibrator mechanism 10 is mild steel or cast iron.

The variable vibrator mechanism 10 therefore obviates or mitigates the disadvantages of previous proposals by providing a vibrator mechanism whose vibration characteristics can be varied remotely without having to stop and disassemble the machinery and change the rotational displacement between fixed and variable weights or add/remove mass to the weights. The variable vibrator mechanism 10 avoids the need for skilled technicians, removes the inherent safety risk and avoids the loss of production due to downtime of the machine.

Modifications and improvements may be made to the above without departing from the scope of the present invention. For example, although the variable vibrator mechanism 10 has been described above as comprising a pair of first members 12, it should be appreciated that the variable vibrator mechanism 10 could comprise any number of first members 12, including a single first member 12, arranged with a single second member 14. Although the variable vibrator mechanism 10 has been described above as being used in a three mechanism apparatus, it should be appreciated that any number of variable vibration mechanisms 10 could be used in a vibrator apparatus. Also, although the variable vibrator mechanism 10 has been described as comprising hydraulic ram shafts 36 which rotationally offsets the first eccentric weight 26 from the second eccentric weight 16, it should be appreciated that any means could be used to provide this function, e.g. the hydraulic ram shafts 36 could be replaced with a threaded shaft which moves into the second member 14 as it is rotated.

Furthermore, although the variable vibrator mechanism 10 has been described above as having first and second eccentric weights 26 and 16 which can be rotationally offset from one another by between approximately 0 degrees and 90 degrees, it should be appreciated that these weights could be offset from one another by any angle. Also, although the variable vibrator mechanism 10 has been described above having the first members 12 mounted within the second member 14, it should be appreciated that the first members 12 may alternatively be mounted on the outer circumferential surface, that is to say the first members 12 telescopically receive the second member 14. Finally, although the variable vibrator mechanism 10 has been described above as being applied to vibrating horizontal screens, it should be appreciated that the variable vibrator mechanism 10 could be applied to other machines which require a vibration to be created from the rotation of eccentric weights e.g. inclined screens, other screens, vibrating feeder machines and road surface hammering devices.

1. A variable vibrator mechanism comprising:
two first members arranged telescopically with a second member,
wherein said first members each have a first eccentric weight and said second member has a second eccentric weight,
wherein said first members and said second member are adapted to be engaged with one another, such that the rotational displacement between said first eccentric weights and said second eccentric weight may be varied by varying the longitudinal displacement between said first members and second member.

2. A variable vibrator mechanism as claimed in claim 1, wherein one of said first members and second member are adapted to receive the other of said first members and second member.

3. A variable vibrator mechanism as claimed in claim 1, wherein said first members and second member are threadably engaged with one another.

4. A variable vibrator mechanism as claimed in claim 3, wherein said second member has two oppositely cut threaded portions to engage said first members.

5. A variable vibrator mechanism as claimed in claim 1, wherein said first members and second member are cylindrical.

6. A variable vibrator mechanism as claimed in claim 1, wherein further comprising means for telescopically displacing said first and second members.

7. A variable vibrator mechanism as claimed in claim 6, wherein the means for telescopically displacing said first and second members is a hydraulic ram.

8. A variable vibrator mechanism as claimed in claim 1, wherein said vibrator mechanism comprises a plurality of pairs of first and second members, wherein each pair of first and second members are arranged telescopically with one another.

9. A vibrating screen machine including a variable vibrator mechanism according to claim 1.

10. A vibrating feeder machine including a variable vibrator mechanism according to claim 1.
